(19) United States
(12) Patent Application Publication
(10) Pub. No.: US 2009/0127451 A1
(43) Pub. Date: May 21, 2009

(54) Devices and Methods for Calibrating Nuclear Medical and Radiological Images

(75) Inventors: Charles Coffey Watson, Knoxville, TN (US); Charles Hayden, Knoxville, TN (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/941,541

(22) Filed: Nov. 16, 2007

(51) Int. Cl. G01N 23/04

(52) U.S. Cl. 250/252.1; 378/207

(57) ABSTRACT

In devices and methods for calibrating nuclear medical and radiological images, an apparatus may be placed in the field of view of a region of interest to be imaged. The apparatus may include a background material with an attenuation characteristic substantially similar to a region of interest of an object being imaged. The background material may include one or more radioactive material embedded in the background material such that when the device is scanned substantially at the same time as the region of interest, the apparatus is a calibration tool.

### TECHNICAL FIELD

The invention relates to medical imaging, and in particular, devices and methods for quantitatively calibrating medical images.

### BACKGROUND

Recently, there has been wide interest in standardizing Positron Emission Tomography (PET) or Single Photon Emission Computed Tomography (SPECT) clinical image quantitation across multiple clinics and the various PET or SPECT's scanners due to, in part, the need for improved accuracy of results in multi-center clinical drug evaluation trials. One principal focus of this effort is on standardizing and ensuring consistency of the so-called “standardized uptake value” (SUV) of lesions in oncological applications.

Currently, there are several efforts underway in the medical imaging community to develop phantoms and methods for performing inter-site cross-calibration in such trials. Phantoms are artificial objects with known emission activity distribution. Typically, the phantom includes a torso-like structure containing several spherical inserts of various sizes, similar to the NEMA NU 2-2001 Image Quality phantom, filled with known quantities of radioactivity. The phantom is generally placed in the scanner and imaged as if it were a patient. The resulting images may be analyzed to characterize absolute accuracy and contrast recovery as a function of the diameters of the spherical inserts.

However, the current approach has significant limitations which hinders the standardization process sought in the field. One main problem is that the response of the imaging system, including the data acquisition, data correction, and reconstruction, depends on the object or patient being imaged. Thus the use of the phantom may give misleading results when compared to human images acquired over the range of conditions generally encountered in a clinic. Variable factors that may not be accounted for with the use of the phantom include: the patient's size (e.g., weight), the lesion's size, shape and location, injected dose, physiological uptake and uptake period, scan duration, data correction accuracy, and reconstruction (e.g., algorithm type, regularization, and post smoothing). In particular, with the most widely used non-linear or iterative reconstructive algorithms, the accuracy of the output images may depend, in part, on the noise level of the input data, which is generally not very well characterized using the phantom. For at least these reasons, a characterization of image accuracy based on separate phantom studies may not be adequate to correctly characterize performance in patient scans.

### SUMMARY

In accordance with the teachings of the present disclosure, disadvantages and problems associated with existing characterization and quantitative analysis of medical images may be substantially reduced or eliminated. In one respect, an image calibration device (ICD) may be provided. The ICD may made include a background material that may substantially match an attenuation characteristic of a region of interest, such as, but not limited to, a tissue sample, a bone sample, an organ, a limb, or any combination therein.

The background material may include a plurality of contrasts having one or more radioactive material. In one respect, the contrasts may be a metal such as aluminium or a plastic such as a high density plastic. The contrasts may be used to align or correct alignments of components in a imaging system. When the ICD is scanned substantially at the same time as the region of interest, the ICD may be used as a calibration tool.

The radioactive material of the contrasts may be used to activate the ICD. The radioactive material may include, without limitation, ¹¹C, ¹⁵O, ¹³N, ¹⁸F, ⁶⁸Ge, ⁶⁸Ga, ²²Na, ⁸²Rb, ¹¹In, ¹²⁴I, ⁶⁷Ga, ^{99m}Tc, ¹²³I, ¹³¹I, ¹³³Xe, ²⁰¹Tl, or any radiopharmaceutical incorporating one or more of these isotopes. Upon activation, the ICD may be simultaneously imaged with a patient, and the resulting images from the imaging devices may be used for calibration. For example, the resulting image of the ICD may be used to calibrate and analyze the patient's image.

In other respects, a method for calibrating a captured image of a patient from a medical imaging device may be provided. The method may include steps for simultaneously imaging a patient and an ICD. Images captured from this step may be used for calibration. In one embodiment, the image of the patient may be calibrated with the image of the ICD.

The method may also provide a graphical user interface to a user, such as a physician. The GUI may allow the user to provide inputs that generate specific areas of interest for calibrating the image of the patient. For example, the user provides data input that may extract information such as, without limitation, partial volume correction, error estimations, detectability limits, and the like.

### BRIEF DESCRIPTION OF THE DRAWINGS

The embodiments will be explained in greater detail in the text which follows by means of diagrammatically represented embodiments in the drawing without the invention being restricted to these embodiments.

FIG. 1 shows a cross sectional view of an ICD placed in proximity of a patient during a scanning process, in accordance to embodiments of the present disclosure.

FIG. 2 shows a cross section view of an ICD including contrasts, in accordance to embodiments of the present disclosure.

FIG. 3 shows a flowchart of a method for calibrating an image, in accordance to embodiments of the present disclosure.

### DETAILED DESCRIPTION

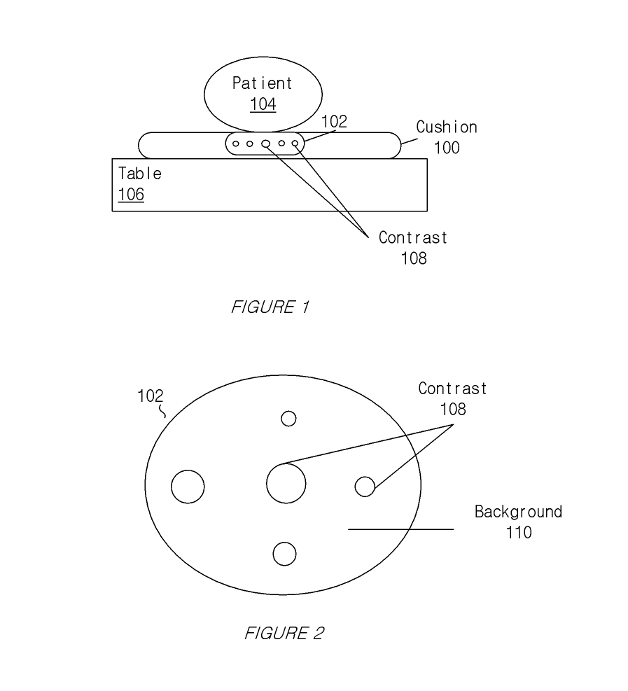

Preferred embodiments and their advantages are best understood by reference to FIGS. 1-3, wherein like numbers are used to indicate like and corresponding parts.

The present disclosure provides devices and techniques for accurately quantifying clinical human nuclear medical images (e.g., PET and single photon emission computerize tomography or SPECT) and radiological images (e.g., CAT scan and magnetic resonance imaging or MRI). In one respect, imaging may be done substantially simultaneously of a phantom (also referred to as an image calibration device, ICD, throughout this disclosure) and of a patient in the same field of view (FOV) of the scanner during the course of clinical data acquisition. The automatic detecting and analyzing of the known region of the ICD may be used to correct information extracted from the patient portion of the image.

Next, a graphical user interface may be provided to a reading physician allowing the physician to apply his or her preferred method of information extraction (e.g., region of interest analysis) to the ICD portion of the image. This step allows for developing customized corrections, such as partial volume correction, based on comparing the results of the patient to the known values of the ICD, and then applying these customized correlations to the information extracted from the patient portion of the image using similar techniques.

### Image Calibration Device

In some respects, various ICDs may be provided for different applications. For example, for a ¹⁸FDG PET/CT oncological application (lesion detection and assessment) using a flat patient table, a particular ICD may be used. The ICD may be constructed using a material similar to water in its attenuation characteristics at both CT x-ray and positron annihilation radiation (approximately 511 keV) energies. Epoxy resin is an example material that may be used. The resin may be activated with a long-lived isotope such as, but not limited to, ⁶⁸Ge/⁶⁸Ga (t_{1/2}=half life˜271 days). Other radioactive materials may be used depending on the application, system used, and half of the isotope. Examples of the radioactive materials include, without limitation, ¹¹C, ¹⁵O, ¹³N, ¹⁸F, ⁶⁸Ge, ⁶⁸Ga, ²²Na, ⁸²Rb, ¹¹¹In, ¹²⁴I, ⁶⁷Ga, ^{99m}Tc, ¹²³I, ¹³¹I, ¹³³Xe, ²⁰¹Tl, or any radiopharmaceutical incorporating one or more of these isotopes The material may include a large region (or background) with uniform radioactive emitter concentration as well as smaller spherical regions with higher or lower emitter concentration than the background. It is understood that other uniform shapes (e.g., cube, pyramid, cylinders, etc.) other than spheres or random shapes may be used, each may have a higher or lower concentration of radioactive emitter compared to the background region.

In other respects, different ICD materials may be used. An alternate design for an ICD for use in a PET/CT may incorporate a background material having a lower density and attenuation than water. This may be helpful for comparison to lung tissue in a patient, where lung tissues may have a density of about 0.3 g/cc. The entire phantom may be composed of this material. Alternatively, the background may include the material and multiple contrasts region having a higher density and/or attenuation than the background, to simulate nodules in a lung. The attenuation contrast regions may also include radioactive emitter concentrations that differ from the background, providing substantially simultaneous contrasts in both their attenuation and emission properties.

Alternatively, in other respects, the background region may be non-activated and thus, may not have an emitter concentration. The total activity level in the ICD may be low such that the radiation dose to the patient from the use of the ICD would be negligible. Additionally, the activity level and thickness of the ICD (which varies in design based on the system and the application) may be designed in such a manner that the ICD would not produce significant degradation of the image quality in the patient portion of the image.

As can be seen from the above examples, the materials used to construct the ICD may vary based on the application as well as the region of the body that is to be imaged. One of ordinary skill in the art can recognize and understand the above are a few examples that may be used, although other suitable materials known in the art may be used separately or in combination with those described in this disclosure.

In one embodiment, the ICD may be embedded in a cushion between the surface of the patient's table and the patient when the patient is positioned for a scan, as shown in FIG. 1. The section of cushion 100, between patient 104 and table 106, may include ICD 102. The section of cushion 100 containing ICD 102 may be positioned relative to patient 104 such that ICD 102 is in the field of view (FOV) during the scan of patient 104. In studies that involve multiple bed positions, ICD 102 may be in the FOV for some or all of the bed positions. Patient 104, cushion 100, and ICD 102 may be positioned so as to bring ICD 102 as close as possible to patient 104, with an air-filled gap (where there is a space between cushion 102 and patient 104) or without an air-filled gap (e.g., cushion 102 is touching patient 104 at some location during a scan).

In other respects, ICD 102 may be positioned differently without the use of a cushion. For example, ICD 102 may be strapped onto the body of patient 104 in the vicinity of the region of interest using straps, tape, string, buckles, or other known strapping methods known in the art. Alternatively, ICD 102 may be fixed in the FOV of the scanner, such that when the patient moves, the ICD 102 may be used concurrently for imaging. As such, patient 104 may move relative to ICD 102 during the course of the scan.

It is understood that more than one ICD may be used during a scanning process. Multiple ICDs may be used during a single bed position, multi-bed position, or continuous bed motion patient scan to provide more complete coverage, or to provide information tailored to different regions of the body, e.g., the lungs versus the liver. The ICDs may also be configured to better mach structures in the body encountered in different disease state.

As noted above, the size, shape, activation, and type of material for the ICD may vary based on the type of imaging system employed, the imaging area, the image reconstruction algorithm, the disease state, and various other factors that may affect image quality and quantitation. For example, referring again to FIG. 1, the dimensions of the components shown may change for many different applications. In one respect, ICD 102 may be a cylindrical shape having a diameter of about ten (10) centimeters and a height of about 2.5 centimeters. However, other shapes and sizes of the overall ICD design may work equally well.

The five spherical regions of contrasts 108 may include diameters of about 5 millimeters, 10 millimeters, 13 millimeters, 17 millimeters, and 22 millimeters arranged in some pattern or placed randomly within background 110. It is noted that the regions of contrast may vary in size and may range, for example, between 0.5 millimeters to 50 millimeters or more depending on the application, region of interest, imaging system, and other factors. Referring to FIG. 2, a cross-sectional view of ICD 102 with contrast regions 108 distributed in background region 110 is shown. Contrast regions 108 are shown in a particular pattern, but other patterns may be used effectively also. While the current embodiment contemplates spherically shaped contrast regions, other choices of shapes, sizes, and the number of contrasts distributed throughout background region 110 may work equally well.

The contrasts discussed may be used for quantitative patient image evaluation as well as to improve co-registration of the multiple images produced by the various component imaging devices of a multi-modality system. To enhance the use of the ICD as a tool for co-registration (e.g., checking and correcting the alignment between or among CT, PET, SPECT, or other medical images), the ICD may include specialized contrast regions that are small in one or more of their spatial dimensions, but have high contrast in attenuation and/or radioactive emitter concentration. Materials such as a metal, e.g., aluminum or the like, and/or a high density plastic may be used to produce well-localized contrast features in the medical image, specifically for the purpose of co-registration. For example, additional materials, in small bead or rod form, may be placed near the edges of the ICD. Alternatively, the ICD may include negative contrast regions, e.g., small voids distributed within the ICD. Any number of such regions may be used to provide contrast to the image. Similarly, in some embodiments, the ICD may not include any such contrast regions.

To reduce or substantially eliminate problems with artifacts due to the sharp transitions in attenuation coefficients, the edges of the ICD may be tapered to produce an effectively smooth transition. Also, the ICD may be designed to match with the curvature of some patient tables.

The activation of the ICD may occur in many different ways. Radioactive material may be added to the ICD. In other words, the ICD may be designed to be refilled with radioactivity. Alternatively, the ICD may be designed to incorporate reconfigurable radioactivity modules.

In one example, for a ¹⁸FDG PET/CT oncological application, the background (e.g., background 110 of FIG. 2) may have a concentration of about 5.3 kBq/ml which corresponds to 370 MBq (10 mCi) dispersed uniformly in 70 liters. The contrast regions (e.g., contrast regions 108 of FIG. 2) may have various ratios of activity concentration relative to the background, e.g., a contrast ratio of 5:1 or other ratios may be used. The contrast regions may all have the same contrast ratio, or alternatively, may have varying among different regions similar to activity concentration as the background. Appropriate radioactivity may be selected and incorporated into the ICD to satisfy a desired contrast ratio(s).

The above specific embodiments illustrate ICDs that may be used in a PET/CT system. It is understood that other similar devices may be constructed to provide intrinsic calibration in a SPECT, CT, or MRI scanning system. For multimodality imaging, multiple similar or identical ICDs in terms of activity concentration may be used in the FOV simultaneously. In effect, a multimodality device may be designed with distinct regions tailored to the types of imaging devices employed.

### Analysis

As noted above, the ICD may be imaged concurrently with a patient undergoing clinical imaging. The data extracted from the matching ICD and patient images may be used for quantitative analysis. For example, in a PET system, absolute quantitation of the uptake of radiopharmaceutical in a lesion within the patient may be analyzed. Similarly, partial volume correction of SUVs, estimation of a standard error of the measurement, estimation of lesion detectability versus the size of the lesion, checking and correcting co-registration between the PET/CT components of a PET/CT image, and others tasks may be affected. In addition, the ICD images collected from the scanning process may be used to automatically produce auxiliary information provided to a physician that would allow the physician to customize the quantifying features in the patient's image to his or her preferences including, but not limited to, the SUV values of lesions. It is further understood that these and similar quantitative analyses for other medical image systems may be based on data extracted from the images collected from the simultaneous scan of a patient and ICD.

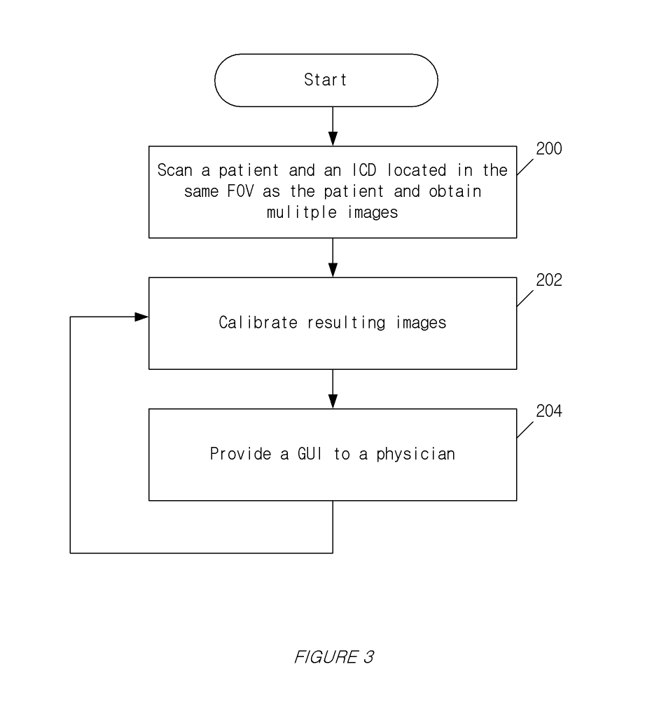

Techniques for calibrating a medical image according to one aspect of the invention are shown in the flowchart of FIG. 3. In step 200, a patient and an ICD located within the same FOV may be scanned, using, for example, a SPECT system, an MRI system, a PET system, a CT system, a PET/CT system, or other suitable medical imaging system known in the art. The result of step 200 may include two images: an ICD image and a patient image. More precisely, the image(s) provided by the medical imaging system may be delineated into two distinct regions, with one corresponding to the patient, and the other corresponding to the ICD. Further, in the case of a multi-modality imaging device such as PET/CT, there may be two (or more) image volumes, one being a PET emission image, and the other being a CT transmission image, each of which may be delineated into two distinct regions for the patient and ICD as mentioned above.

Using the resultant images from step 200, in step 202, data extracted from the ICD image(s) may be used to calibrate the image of the patient. In one embodiment, the calibration process can be automated by employing appropriate software algorithms. For example, one or more pre-determined template image(s) of the known ICD may be stored in computer memory. The algorithm may apply the stored template to clinical image(s) using a correlation or matching technique to determine the precise location of the ICD in the actual clinical image(s). Once the precise location of the ICD is determined, the algorithm may define certain regions of interest (ROI) within the ICD region of the clinical image and evaluate quantitative measures of the clinical image within these ROI. For example, various quantitative measures such as, but not limited to, the mean and standard deviation (SD) of the image pixel values over the ROI may be evaluated. These quantitative data, together with the known coordinates of the ROIs (as determined for the template matching process), may be used in a variety of ways for quantitative analysis and calibration of the patient portion of the clinical image(s).

The coregistration accuracy of two image volumes in a multi-modality scan (e.g., PET/CT) may be determined by comparing the measured locations of certain ROI in each image. In one embodiment, any significant alignment errors thus determined may be corrected by rotating or shifting one image relative to the other as part of the image display process of the imaging device.

In some embodiments, step 202 may also include analyses of the uniform background region in the ICD portion of the clinical image(s) to determine its quantitative accuracy. For example, in a PET or SPECT emission image, the mean value of the appropriate ROI in the ICD image may be compared to known, true value of the radioactive emitter concentration in that region of the ICD. It is understood that this evaluation may be performed whether the image values are expressed in terms of absolute emitter concentration (Bq/cc), or in some proportional unit such as SUV.

In other embodiments, a mean value of an x-ray attenuation coefficient in a corresponding ROI of a CT image (as expressed in Hounsfield units) may be compared to its known, true value. These quantitative image ROI values may be reported to the user, together with their absolute error and SD (step 204).

Alternatively or in addition, these quantitative ROI values (measured and true) may be used to correct the clinical images to improve their accuracy. In one embodiment of this correction, a scale factor may be formed from the ratio of the true value to the measured value. This scale factor may then be multiplicatively applied to each pixel value in the corresponding clinical image.

According to another aspect of the invention, multiple ROIs of varying size may be defined in the background region of the ICD image, and the SD of each computed. In one embodiment, these data may be reported to the user as a measure of the noise level in the image, one indicator of image quality.

According to another aspect of the invention, ROIs drawn on the emitter contrast regions in the PET or SPECT emission ICD image may be evaluated according to one or more of the methods commonly used for the evaluation of SUV values in human lesions. These methods include, but are not limited to: mean value over the ROI, maximum value, or mean value above a threshold. In one embodiment of the invention, these values measured as a function of the size of the contrast regions may be reported to the user together with the true values of the emitter concentrations in these ROIs in order to give the user an understanding of the magnitude of the partial volume error in quantifying the SUV values of lesions in the patient image. In another embodiment of the invention, the measured fractional loss in contrast value may be modelled as a function of spherical contrast region size, and inverted to provide a multiplicative correction factor as a function of lesion size that may then be applied to correct quantitative measurements made on lesions in the patient image, such as SUV or emitter concentration.

According to another aspect of the invention, a characterization of the detectability of lesions of various sizes in the patient image may be developed by applying a quantitative detectability measure such as, but not limited to, a non-pre-whitening matched filter, to the ICD portion of the image. In one embodiment of the invention, the detection results from the ICD may be reported to the user to provide an understanding of the reliability of lesion detection in the patient portion of the image.

Using the resultant images from step 200, in step 202, data extracted from the ICD image may be used to calibrate the image of the patient. In one respect, for a PET/CT components of the PET/CT system may be evaluated for alignment, by evaluating the contrasts in the ICD image.

Step 202 may also include analysis of the resulting images with respect to the activity concentration levels (Bq/cc). In one embodiment, a background activity level from the patient's image may be extracted and may be compared with absolute activity concentration of the ICD image. Any discrepancy may be reported.

The patient's image may also be analyzed for accuracy. For example, SUV values in the patient's image may be cross-checked. A pixel-to-pixel noise variation estimation over a uniform region may be determined. A lesion detectability measure based on an estimation of, for example, matched filter signal-to-noise ration may be evaluated. In addition or alternatively, the specific partial volume correction and error estimation may be reported for a region of interest (ROI) quantitative analysis of lesions. The patient's image may also undergo an optional global calibration technique to update the image.

The ICD image may be evaluated for multiple reasons. For example, a reliability measure (standard deviation) from multiple regions of interest (ROI) may be determined. An estimation of partial volume/contrast recovery factors for each contrast sphere size, computed according to known ROI analysis technique may be calculated.

In addition to the above, step 202 may provide a mechanism for optimizing the reconstruction of the data. In an iterative reconstruction algorithm, such as, but not limited to, the OSEM algorithm, at each iteration, the ICD image quality may be evaluated for a particular task, such as lesion detection or quantitation. For example, a possible metric for optimizing detectability may be to determine the contrast to noise ratio in the spheres of the ICD. A possible metric for optimizing quantitation may be determining a total RMS error between an image and known true activity distribution. For a linear algorithm, such as, but not limited to filtered back-projection, post-filtering may be optimized.

In step 204 of FIG. 3, a graphical user interface (103) may be provided to a physician. The GUI may provide a physician the capability to customize the information needed from the captured images. In one respect, the physician may need to perform a detection and quantitative analysis on the ICD image using a similar technique known for analyzing the patient's image. For example, the GUI may provide a physician the ability to select a region of interest around spherical region on the ICD image as if they were lesions. The method may revert to step 202 to calibrate the results of the patient's image and the ICD image and analyze, for example, partial volume correction, error estimation, detectability limit, and the like specifically adapted to the physician's need.

The techniques shown, for example, in FIG. 2, may be embodied in instructions of a software program that may be executable on a tangible computer readable media. As used in this disclosure, “tangible computer readable media” means any instrumentality, or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or storage.

The computer-readable media may be embodied internally or externally on a hard drive, ASIC, CD drive, DVD drive, tape drive, floppy drive, network drive, flash drive, USB drive or the like. Further, the computer-readable media may be any computing device capable of executing instructions for implementing the method shown, for example, in FIG. 3. In one embodiment, the computer-readable media may be a personal computer (e.g., a typical desktop or laptop computer operated by a user). In other embodiments, a computer-readable media may be a personal digital assistant (PDA) or other handheld computing device.

In some embodiments, the computer-readable media may be a networked device and may constitute a terminal device running software from a remote server, wired or wirelessly. Input from a user or system components may be gathered through one or more known techniques such as a keyboard and/or mouse. Output, if necessary, may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash, or the like. The computer readable-media may use any type of monitor or screen known in the art, for displaying information, for example, a GUI for the physician. For example, a cathode ray tube (CRT) or liquid crystal display (LCD) can be used. One or more display panels may also constitute a display. In other embodiments, a traditional display may not be required, and computer readable-media may operate through appropriate voice and/or key commands.

1. An image calibration apparatus comprising:
a background material comprising an attenuation characteristic substantially similar to a region of interest of an object being imaged; and
a plurality of contrast regions comprising one or more reconfigurable radioactivity modules embedded in the background material;
wherein when the apparatus is scanned substantially at the same time as the region of interest, the apparatus is a calibration tool.

2. The apparatus of claim 1, wherein each of the plurality of contrast regions has a dimension ranging from about 0.5 millimeters to about 50 millimeters.

3. The apparatus of claim 1, wherein the background region is uniformly activated with a radioactive material.

4. The apparatus of claim 1, wherein one or more of the plurality of contrast regions differ in attenuation characteristics from the background material.

5. The apparatus of claim 1, wherein one or more of the plurality of contrast regions differ in emitter concentration from the background material.

6. (canceled)

7. The apparatus of claim 1, wherein the region of interest comprises an organ, a tissue sample, a limb, one or more bones, or any combination thereof.

8. The apparatus of claim 1, the background material comprising water, a resin, or a plastic.

9. The apparatus of claim 1, the material being embedded into a cushion placed in a field of view together with the region of interest.

10. The apparatus of claim 1, the radioactive material comprising ¹¹C, ¹⁵O ¹³N, ¹⁸F, ⁶⁸Ge, ⁶⁸Ga, ²²Na, ⁸²Rb, ^{“1}Ga, ^{99m}Tc, ¹²³I ¹³¹I, ¹³³Xe, ²⁰¹Tl, or any adiopharmaceutical incorporating one or more of these isotopes.

11. The apparatus of claim 1 having a cylindrical shape with a diameter of about ten (10) centimeters and a height of about 2.5 centimeters.

12. The apparatus of claim 1 being embedded into a cushion placed in a field of view as the region of interest.

13. A method for calibrating a captured image of a patient from a medical imaging device comprising:
imaging a patient and an image calibration device at substantially the same time, wherein the calibration device is configured to be refilled with radioactivity;
capturing an image of the patient;
capturing an image of the image calibration device; and
calibrating the image of the patient using the image of the calibration device.

14. The method of claim 13, further comprising placing the image calibration device in a same field of view as a patient.

15. The method of claim 13, further comprising activating the image calibration device with an isotope prior to imaging.

16. The method of claim 13, further comprising providing a graphical user interface to a user, the graphical user interface providing a user defined input to calibrate the image of the patient.

17. An nuclear medical imaging or radiological imaging system comprising:
an object table and an image calibration tool arranged on the object table between the object and the object table, the calibration tool comprising:
a background material comprising an attenuation characteristic substantially similar to a region of interest of an object being imaged; and
a plurality of contrast regions comprising one or more reconfigurable radioactivity modules embedded in the background material.

18. The system of claim 17, wherein the material is embedded into a cushion placed on the object table.

19. The system of claim 17, wherein each of the plurality of contrast regions having a dimension ranging from about 0.5 millimeters to about 50 millimeters.

20. The system of claim 17, wherein the background region is uniformly activated with a radioactive material.
